(19) United States
(12) Patent Application Publication
(10) Pub. No.: US 2008/0226432 A1
(43) Pub. Date: Sep. 18, 2008

(54) Storage and Retrieval Unit and Method For Longitudinal Positioning on a Shelf in a Commissioning System

(76) Inventor: Karl Freudelsperger, Hart bei Graz (AT)

Correspondence Address: MCGLEW & TUTTLE, PC, P.O. BOX 9227, SCARBOROUGH STATION, SCARBOROUGH, NY, 10510-9227, US

(21) Appl. No.: 10/597,435

(22) PCT Filed: Feb. 14, 2005
(86) PCT No.: PCT/EP2005/001468

§ 371 Date: Jul. 25, 2006

(30) Foreign Application Priority Data
Feb. 16, 2004 (DE) 10 2004 007 411.9

(51) Int. Cl. B65G 1/12

(52) U.S. Cl. 414/280; 414/807

(57) ABSTRACT

A storage and retrieval unit (1) and a method for transporting goods (2) from or to a shelf (3) in a commissioning unit are provided. The storage and retrieval unit includes a vertical mast (4) and a longitudinal drive (5), linked with the mast, for longitudinally displacing and longitudinally positioning the storage and retrieval unit on a site of operation of the shelf on the shelf front or the shelf rear. A height-adjustable goods receiver (7) is provided on the vertical mast. The is configured as an articulated mast (4) having at least one joint (8) which enables a deflection (A) of the articulated mast in the direction of longitudinal displacement (L). A guide/readjusting device (9) having articulated rods, especially an articulated oscillating crank (9′), is provided on the articulated longitudinal end of the articulated mast for the purpose of stability. When the articulated mast (4) is deflected in a guided manner (A), said oscillating crank returns the articulated mast (4) from the vertical normal operating position (N) back to the normal operating position in a guided manner. Optionally, the guide/readjusting device (9) can also be or comprise a bent guide, especially a sliding guide.

### CROSS REFERENCE TO RELATED APPLICATIONS

This application is a United States National Phase application of International Application PCT/EP2005/001468 and claims the benefit of priority under 35 U.S.C. § 119 of German Patent Application DE 10 2004 007 411.9 filed, the entire contents of which are incorporated herein by reference.

### FIELD OF THE INVENTION

The present invention pertains to a storage and retrieval unit as well as to a method for the longitudinal positioning of the storage and retrieval unit at a site of operation of a shelf on the shelf front or the shelf rear, wherein a height-adjustable goods receiver is provided at a vertical mast.

### BACKGROUND OF THE INVENTION

An above-mentioned, prior-art storage and retrieval unit is frequently guided in rails on the bottom side within a commissioning system and is displaceable in parallel or longitudinally on the shelf front or the shelf rear by means of an electric motor and can be positioned at a selected site of operation of the shelf. The storage and retrieval unit usually has a traveling tower or a vertical mast at the level of the shelf to be operated, usually in a warehouse, wherein the shelf may extend over several levels or stories. Because of the relatively great height of the traveling tower, the storage and retrieval unit is comparatively unstable due to the bottom-side drive. Additional stability is achieved due to a complicated construction of the traveling tower and an additional longitudinal guiding of the storage and retrieval unit in the area of the ceiling of the warehouse or in the area of the top side of the shelf. Besides the bulky design, it is disadvantageous that the storage and retrieval unit can be displaced only relatively slowly and can be positioned at a desired site of operation of the shelf in a relatively time-consuming manner only. If the tall traveling tower is being moved or cycled too fast, there is a risk that the traveling tower will tilt or jam in the area of the ceiling or the top side of the shelf. However, the traveling tower is at least exposed to great bending moments, and the upper longitudinal guide is subject to heavy load and to great wear.

To eliminate the above-mentioned drawback, a second, top-side longitudinal drive, which is operated synchronously with the bottom-side drive, is known in a storage and retrieval unit, in addition to the bottom-side drive according to the state of the art, for example, according to DE 202 05 633.3. It is advantageous here that faster displacement and positioning of a storage and retrieval unit in front of or behind a shelf or within a complex commissioning system is possible as a result and the traveling tower of the storage and retrieval unit can have a relatively slender design, because the dynamic bending forces are diverted by means of the second, top-side longitudinal drive.

However, it was found that precisely in case of great heights of the vertical mast or traveling tower over a plurality of levels of a shelf in a tall, usually multi-story building, the long mast itself is subject to strong transverse acceleration forces during faster travel, especially because the vertical mast carries the load to be commissioned, and faster displacement and positioning of the storage and retrieval unit is possible as a result only conditionally. Moreover, the storage and retrieval unit must be designed for an emergency stop and have a correspondingly stable design. Consequently, the forces occurring at the long mast are always transmitted via long levers. In particular, the bending moments occurring at the mast in emergency stop situations are very high, and they cause problems above all at the end position buffers. Even in case of an additional drive at the upper mast guide, strong forces will consequently sometimes develop at the support points of the upper and lower chassis, especially because, due to the additional drive, new forces may be introduced into the system, which is no longer determined statically.

### SUMMARY OF THE INVENTION

The object of the present invention is to create a storage and retrieval unit of the type mentioned in the introduction, which makes possible fast and stable, reliable longitudinal positioning at a site of operation of the shelf with astonishingly simple means even in case of a comparatively great mast height.

The object of the present invention is, furthermore, to create a simplified working method for the longitudinal positioning of the above-mentioned storage and retrieval unit.

According to the invention, a storage and retrieval unit is provided for transporting goods from or into a shelf in a commissioning system. The unit includes a vertical mast and a longitudinal drive connected to the mast for longitudinal displacement and longitudinal positioning of the storage and retrieval unit at a site of operation of the shelf on the shelf front or the shelf rear. A height-adjustable goods receiver is provided at the vertical mast. The vertical mast includes an articulated mast with a joint, which makes possible a deflection (A) of the articulated mast in the direction of longitudinal displacement (L). A guide/readjusting device is provided. This may include articulated rods including an articulated oscillating crank, which returns the articulated mast into the normal position upon a guided deflection (A) of the articulated mast from the vertical normal position, for stabilization at the deflectable longitudinal end of the articulated mast.

According to a further aspect of the invention, a method for longitudinally positioning the storage and retrieval unit at a site of operation of the shelf is provided. The method includes providing a storage and retrieval unit as noted and displacing the storage and retrieval unit linearly in the longitudinal direction (L) of the shelf from a resting starting position of the shelf (3) in an accelerated manner toward a selected site of operation of the shelf and in a decelerated manner before the site of operation is reached in such a way that the articulated mast is deflected in a guided manner during at least part of the accelerated and/or decelerated motion and is again returned in a guided manner into the aligned vertical normal position at least during stoppage of the storage and retrieval unit.

The essence of the present invention is that in a storage and retrieval unit of the type in question, the mast is designed as an articulated mast and has at least one joint, which makes possible the deflection of the articulated mast in the direction of longitudinal displacement. In the area of the deflectable mast end, the articulated mast is equipped here for stabilization with a guide/readjusting device, which returns the articulated mast into the normal position in a guided manner in case of the guided deflection of the articulated mast from the vertical normal position. The guide of the articulated mast is designed such that even though the deflectable end of the articulated mast can pivot unhindered in the direction of longitudinal displacement in an arc-shaped pattern, on the one hand, it is guided restrictedly at least in the transverse direction, and, in particular, it is also guided restrictedly along the “arc” in the longitudinal direction, on the other hand.

The joint is preferably located in the area of the longitudinal drive, which is arranged especially in the area of the upper or lower mast end. In a special variant, the articulated mast is either suspended on an upper chassis or is supported on a lower chassis.

In a special embodiment, the guide/readjusting device has another longitudinal drive of the type of the first longitudinal drive, and both longitudinal drives are preferably operated synchronously.

The two synchronously driven longitudinal drives are preferably controlled such that the tilting mast continues to be arranged vertically during the normal operation of longitudinal displacement of the storage and retrieval unit, while guided deflection of the tilting mast takes place in case of an emergency stop of the storage and retrieval unit.

However, the two longitudinal drives may also be controlled such that the storage and retrieval unit is displaced linearly in the direction of the shelf from a resting starting position of the shelf, accelerated toward a selected site of operation of the shelf and decelerated before the site of operation is reached, such that the articulated mast is deflected in a guided manner during at least part of the accelerated and/or decelerated motion and is again adjusted in a guided manner into the aligned vertical normal position at least during stoppage of the storage and retrieval unit.

Great mast heights of a storage and retrieval unit can be advantageously embodied by the present invention, and the storage and retrieval unit can be displaced equally fast and reliably, without break in the normal operation, and emergency operation or an emergency stop is also possible without rupture of individual parts and without excessive load on the support points of the one or more chassis. If longitudinal drives are arranged at the top and at the bottom, the traveling system is likewise operated in a statically determined manner. Thus, the traveling system forgives minor asynchronisms in the two longitudinal drives. End position buffers in the shelf can be made as relatively short buffers, e.g., relatively short buffer paths are provided. A special advantage of the present invention is that because of the relatively low stress on the bearing points of the one or more chassis, the chassis can be designed as compact, especially short and lightweight chassis, without the chassis being able to tilt, and a longer operating area can also be obtained in the bay aisle.

Other advantageous features of the present invention appear from the following description, in which preferred exemplary embodiments of the present invention will be explained in greater detail on the basis of the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic perspective cut-away view of storage and retrieval units according to the present invention arranged in a bay aisle of a double shelf of a commissioning system;

FIG. 2 is a first embodiment variant of the storage and retrieval unit according to FIG. 1;

FIG. 3 is a second embodiment variant of the storage and retrieval unit according to FIG. 1;

FIG. 4A is a side view of the storage and retrieval unit according to FIG. 2 in one of two deflected positions;

FIG. 4B is a side view of the storage and retrieval unit according to FIG. 2 in another of two deflected positions;

FIG. 5 is a side view of the storage and retrieval unit according to FIGS. 4A and B, shown in a vertical normal position;

FIG. 6 is a front view of the storage and retrieval unit according to FIG. 5;

FIG. 7 is a perspective view of upper and lower details of the storage and retrieval unit according to FIGS. 2 and 4A through 6;

FIG. 8 is a force diagram of a storage and retrieval unit according to FIG. 2;

FIG. 9 is a force diagram of a storage and retrieval unit according to the state of the art;

FIG. 10A is a side view of the second embodiment variant of the storage and retrieval unit according to FIG. 3, in one of two deflected positions;

FIG. 10B is a side view of the second embodiment variant of the storage and retrieval unit according to FIG. 3 in another of two deflected positions;

FIG. 11 is a side view of the storage and retrieval unit according to FIGS. 10A and B, shown in a vertical normal position; and

FIG. 12 is a front view of the storage and retrieval unit according to FIG. 11;

FIG. 13 is a perspective view of upper and lower details of the storage and retrieval unit according to FIGS. 3 and 10A through 12.

### DESCRIPTION OF THE PREFERRED EMBODIMENTS

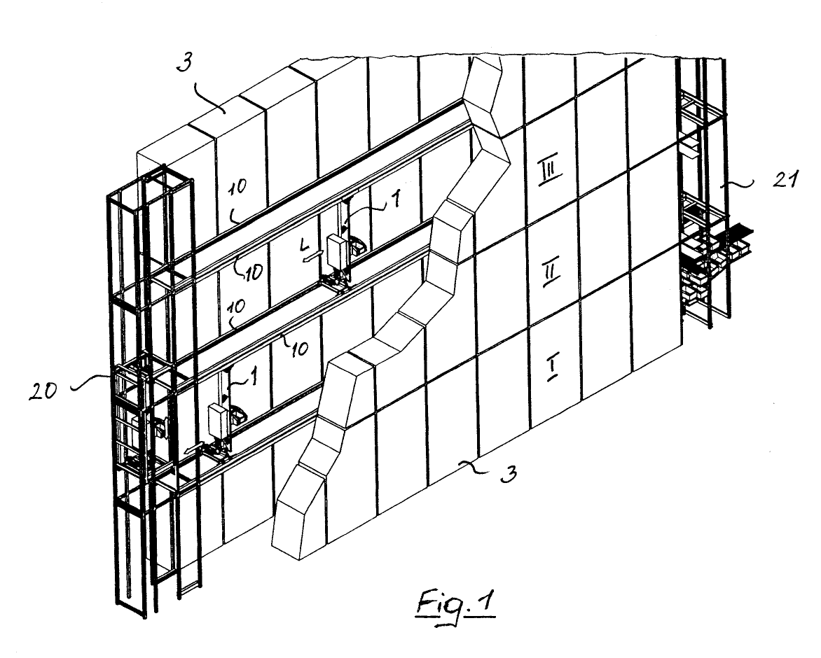

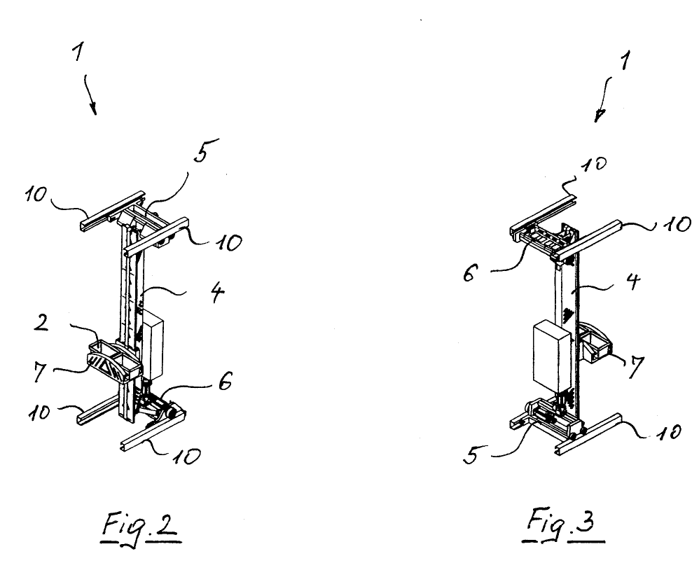

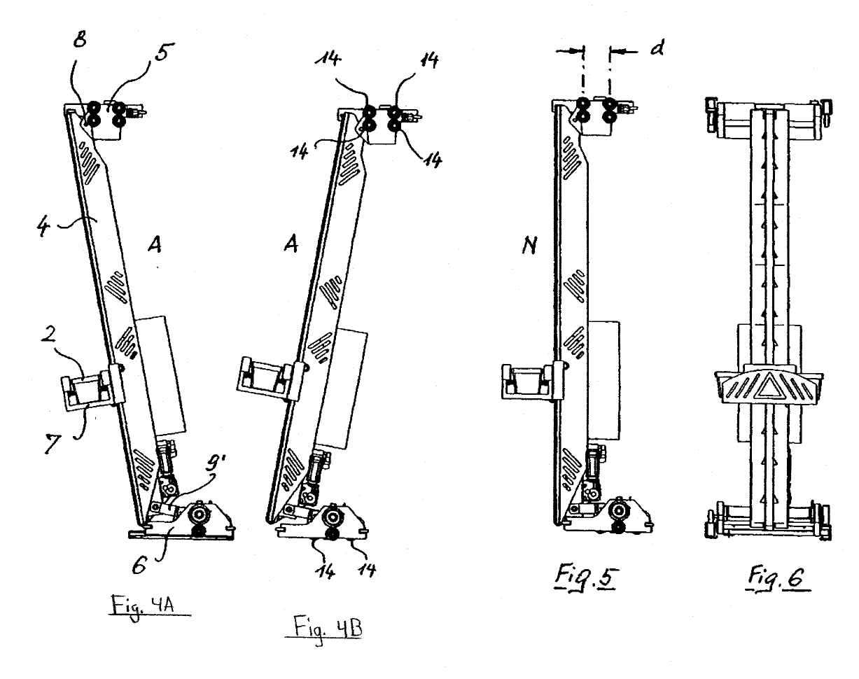

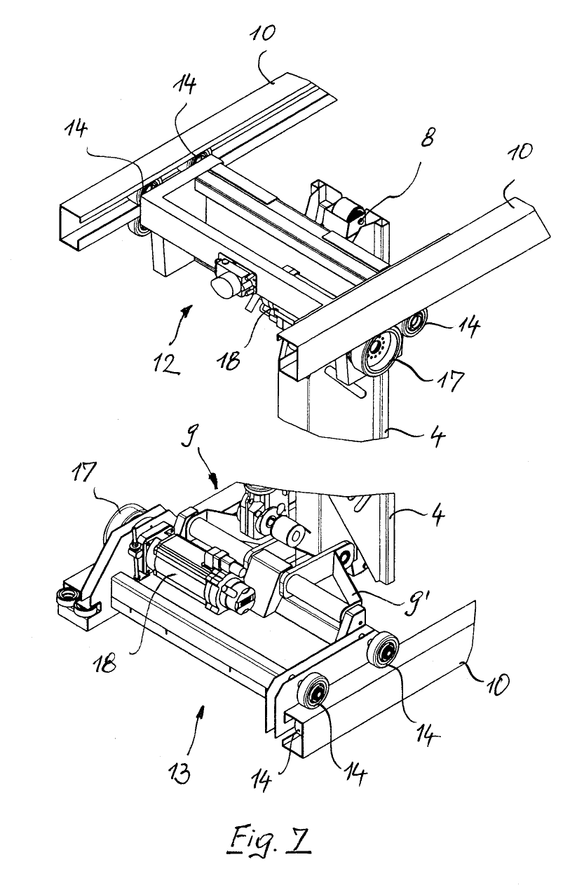

Referring to the drawings in particular, a commissioning system, which is not particularly of interest here, comprises a double shelf according to FIG. 1, comprising two shelves 3 with a storage and retrieval unit 1 arranged in the bay aisle, either in the embodiment variant according to FIG. 2 or in the embodiment variant according to FIG. 3.

According to FIG. 1, the storage and retrieval units 1 are guided on the top side and on the bottom side in rails 10, which are integrated parts of the shelves 3, i.e., components of the shelves.

The storage and retrieval units 1 can be displaced horizontally in the longitudinal direction L of the shelves 3 in the bay aisle in levels I, II, III of the shelves 3, which levels are arranged one on top of another, and operate shelf fronts facing them.

The storage and retrieval units 1 can be displaced vertically by means of an elevator 20 from one shelf level into another selected shelf level and used in this shelf level in the bay aisle by horizontal displacement.

The elevator 20 according to FIG. 1 is located at a longitudinal end of the shelves 3. A material or goods elevator 21, which transports goods to be commissioned vertically into the selected shelf level before the storage and retrieval unit 1 located there grasps the goods for introduction into a shelf 3 or releases them there after retrieving them from the shelf, is located at the other longitudinal end of the shelves. The goods 2 may also be displaced vertically in the elevator 20 together with the storage and retrieval unit 1.

A storage and retrieval unit 1 according to FIG. 1 has a vertical mast 4 and has, on the one hand, a longitudinal drive 5 connected to the mast at the top and, on the other hand, another longitudinal drive 6 at the bottom according to FIG. 2 for longitudinal displacement and longitudinal positioning of the storage and retrieval unit at a site of operation of the shelf on the shelf front and on the shelf rear, a height-adjustable goods receiver 7 being provided at the vertical mast.

In particular, the mast is designed as an articulated mast 4 with a joint 8, which makes possible the guided deflection A of the articulated mast in the direction of longitudinal displacement L, as this is shown in FIGS. 4A and 4B.

The joint 8 is located at the upper end of the mast in the area of the upper longitudinal drive 5.

In particular, the articulated mast 4 is suspended on an upper chassis 12 according to FIG. 7 in a pendular arrangement. At the other, lower deflectable mast end, the articulated mast 4 has a guide/readjusting device 9 for stabilization, which returns the articulated mast 4 into the normal position in a guided manner in case of a guided deflection A of the articulated mast 4 from the vertical normal position N. The guiding of the articulated mast is designed such that even though the deflectable end of the articulated mast can pivot unhindered in the direction of longitudinal displacement in an arc-shaped pattern, on the one hand, it is guided restrictedly at least in the transverse direction, especially it is also guided restrictedly along the “arc” in the longitudinal direction, on the other hand.

The guide/readjusting device 9 is connected to the lower other longitudinal drive 6 in an articulated manner.

The upper and lower longitudinal drives 5, 6 are essentially of identical design. Both longitudinal drives 5, 6 are driven synchronously such that the articulated mast 4 is arranged vertically according to FIG. 5 during the normal operation of the longitudinal displacement L of the storage and retrieval unit 1, and that guided deflection A of the articulated mast 4 takes place during an emergency stop of the storage and retrieval unit according to FIG. 4, depending on the direction of action of the decelerating force.

The guide/readjusting device 9 has articulated rods, especially an articulated oscillating crank 9′, which is pivotable about a horizontal axis, the lower end of the mast being connected to the oscillating crank 9′ in an articulated manner.

A bent guide, especially a sliding guide with lateral sliding blocks at the deflectable end of the articulated mast, which [said guide/readjusting device] makes possible the exact bent guiding of the deflectable end of the articulated mast during unhindered deflection of the articulated mast along the arc and clearance-free guiding in the transverse direction, may be provided, in particular, at the deflectable mast end.

The guide/readjusting device 9 may also comprise elastic readjusting means.

In a special embodiment, the upper and lower chassis 12, 13 have four horizontal axes with end-side rollers 14, which are guided nontiltingly in the rails 10, wherein two axes each are arranged one on top of another and the two axis pairs are located at horizontally spaced locations from one another, preferably at a distance d corresponding to 2 to 3 times the diameter of the rollers 14, as this is shown in FIG. 5.

The respective chassis 12 and 13 have an electric drive 18 of their own with a friction wheel 17 as the driving wheel, which meshes with one of the rails 10 in a friction-rolling driving manner.

The articulated mast 4, especially the joint 8, may also have a blocking device (not shown), which prevents deflection A of the articulated mast up to a mast load limit value and permits the deflection A of the articulated mast 4 when the mast load limit value is exceeded.

The mast load limit value may optionally be set. The mast load limit value may be a lateral force limit value of the articulated mast 4 or an acceleration/deceleration limit value of the longitudinally displaceable storage and retrieval unit.

An above-mentioned storage and retrieval unit 1 according to FIGS. 2 and 4 through 7 can be operated not only in such a way that the articulated mast 4 continues to be arranged vertically according to FIG. 5 during the normal operation of a longitudinal displacement of the storage and retrieval unit 1, while guided deflection A of the articulated mast 4 takes place according to FIG. 4 in case of an emergency stop of the storage and retrieval unit, but also such that the storage and retrieval unit 1 is displaced linearly in the longitudinal direction L of the shelf, in case of corresponding control, from a resting starting position of the shelf 3, accelerated to a selected site of operation of the shelf and decelerated before the site of operation is reached, such that the articulated mast 4 is deflected in a guided manner during at least part of the accelerated and/or decelerated motion according to FIG. 4 and is again readjusted in a guided manner into the aligned vertical normal position N according to FIG. 5 at least during stoppage of the storage and retrieval unit.

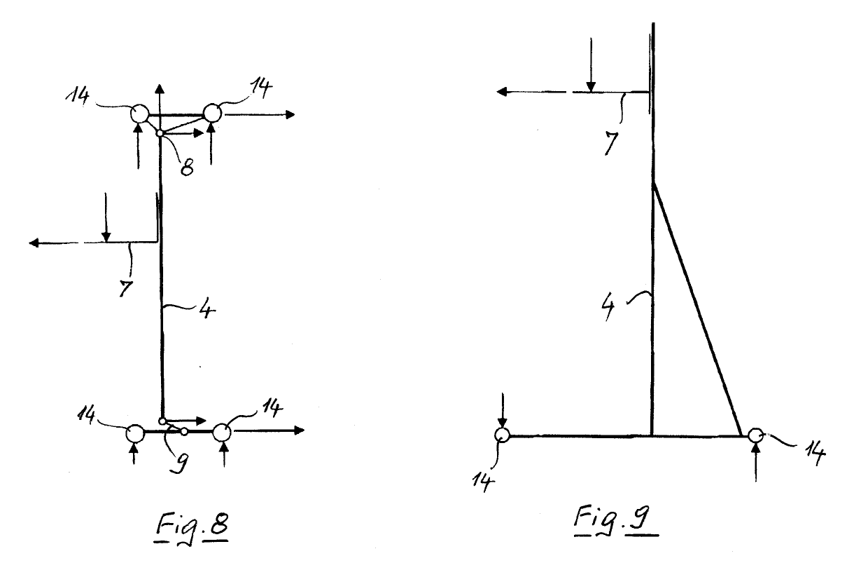

FIG. 8 schematically shows the above-mentioned storage and retrieval unit 1 according to the present invention with the articulated mast 4 suspended at the upper chassis 12 in the joint with respect to the action of forces, while FIG. 9 shows the forces in the state of the art with rigid mast and lower chassis 13.

According to FIG. 9, the forces are transmitted at the vehicle (chassis) via large levers according to the state of the art. High bending moments, which cause problems especially in emergency stop situations at the end position buffers of the shelf 3 and the rails 10, occur at the mast. The consequence of this is long buffer paths in order to keep the deceleration/acceleration low. Strong forces will sometimes develop at the support points of the chassis and the rollers 14 even if an additional drive is used at the upper mast guide, because new forces are introduced due to the additional drive. The system is no longer determined statically.

According to FIG. 8, the mast is suspended, by contrast, in an articulated manner according to the present invention at the upper guide carriage as an articulated mast 4 via a joint 8. The lower carriage is used for stabilization only, i.e., for the vertical alignment of the mast. This pendular arrangement with the formation of an oscillating crank cannot tilt in case of error. The system also cannot self-destruct in case of error, either, e.g., in case of rupture of the belt in a toothed belt drive or in case of failure of the needed frictional engagement in a friction wheel drive. The maximum bending moments in the articulated mast 4 are low. The forces are introduced at the upper guide carriage at the hinge point of the mast. The energy of impact at the end positions is divided between the two guide carriages. It is also possible to embody shorter buffer paths due to the lower moments to be expected in case of an impact.

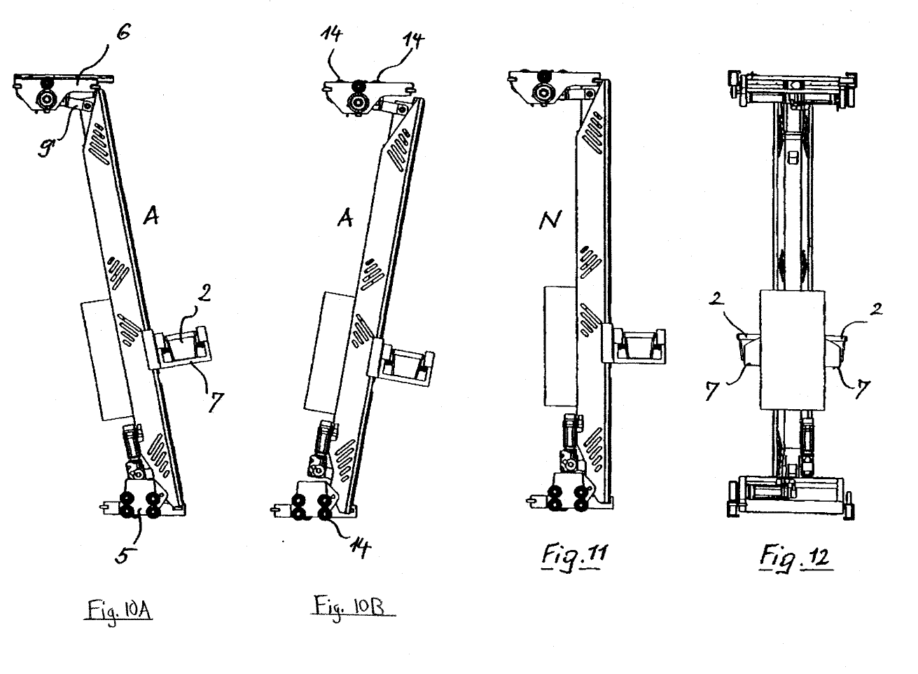

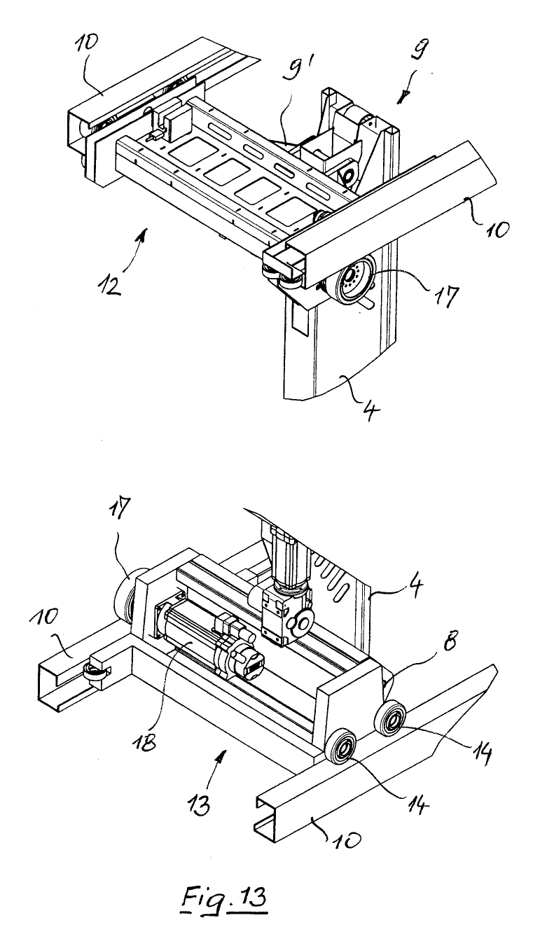

While the articulated mast 4 is suspended in an articulated manner at the top at the upper chassis 12 in case of an upper joint 8 at the upper end of the mast in the first embodiment variant described above, the arrangement is shown inverted concerning the articulated mast and is stabilized at the lower chassis by means of articulated rods with an oscillating crank 9′, the arrangement is shown inverted concerning the articulated mast, the hinge point and the chassis according to FIGS. 3 and 10, i.e., the articulated mast 4 is supported at a lower joint 8 at the lower end of the mast at the lower chassis 13 in an articulated manner, and the deflectable mast end is provided at the upper chassis 12 with the oscillating crank 9′ and the guide/readjusting device 9, etc. Corresponding components of this second variant otherwise have a design identical or similar to that in the first variant.

While specific embodiments of the invention have been shown and described in detail to illustrate the application of the principles of the invention, it will be understood that the invention may be embodied otherwise without departing from such principles.

1. A storage and retrieval unit for transporting goods from or into a shelf in a commissioning system, the unit comprising:
a vertical mast;
a longitudinal drive connected to the mast for longitudinal displacement and longitudinal positioning of the vertical mast at a site of operation of the shelf on the shelf front or the shelf rear;
a height-adjustable goods receiver provided at the vertical mast, said vertical mast comprising an articulated mast with a joint, which makes possible a deflection of the articulated mast in the direction of longitudinal displacement, and a guide/readjusting device with articulated rods, including an articulated oscillating crank, which returns the articulated mast into the normal position upon a guided deflection of the articulated mast from the vertical normal position for stabilization at the deflectable longitudinal end of the articulated mast.

2. A storage and retrieval unit in accordance with claim 1, wherein the joint is located in the area of the longitudinal drive.

3. A storage and retrieval unit in accordance with claim 1, wherein the longitudinal drive is arranged in the area of an upper or lower mast end wherein the articulated mast is suspended on an upper chassis or is supported at a lower chassis.

4. A storage and retrieval unit in accordance with claim 1, wherein the guide/readjusting device has another longitudinal drive wherein the longitudinal drives may be operated synchronously.

5. A storage and retrieval unit in accordance with claim 4, wherein the two longitudinal drives are operated synchronously such that the articulated mast is arranged vertically during the normal operation of a longitudinal displacement of the storage and retrieval unit, and that guided deflection of the articulated mast takes place in case of an emergency stop of the storage and retrieval unit.

6. A storage and retrieval unit in accordance with claim 1, wherein the guide/readjusting device comprises an elastic readjusting means.

7. A storage and retrieval unit in accordance with claim 1, wherein the goods receiver adjustable in height at the articulated mast and is located in the area of the joint for the longitudinal displacement of the storage and retrieval unit to a site of operation of the shelf on the shelf front or on the shelf rear.

8. A storage and retrieval unit in accordance with claim 3, wherein the upper and/or lower chassis is/are guided in a nontilting manner in rails.

9. A storage and retrieval unit in accordance with claim 8, wherein the rails are integrated parts of the shelf.

10. A storage and retrieval unit in accordance with claim 3, wherein the chassis has at least four axes with said end-side rollers, which are guided in said rails in a nontilting manner, wherein two axes each are arranged as an axis pair one on top of another and the two axis pairs are located at horizontally spaced locations from one another at a short distance (d), preferably at a distance (d) corresponding to 2 to 3 times the diameter of the roller.

11. A storage and retrieval unit in accordance with claim 10, wherein the chassis has an electric drive of its own with a friction wheel (17) as a driving wheel, which meshes with one of the rails in a rolling-driving manner.

12. A storage and retrieval unit in accordance with claim 1, wherein the articulated mast or the joint of the articulated mast, has a blocking device, which prevents deflection of the articulated mast up to a mast load limit value and permits deflection y of the articulated mast when the mast load limit value is exceeded.

13. A storage and retrieval unit in accordance with claim 11, wherein the mast has a load limit value that can be set.

14. A storage and retrieval unit in accordance with claim 12 wherein the mast load limit value is a lateral force limit value of the articulated mast or an acceleration/deceleration limit value of the longitudinally displaceable storage and retrieval unit.

15. A storage and retrieval unit in accordance with claim 1, wherein the guide/readjusting device comprises, a bent guide, comprising a sliding guide with lateral sliding blocks at the deflectable end of the articulated mast, which makes possible an exact bent guiding of the deflectable end of the articulated mast during unhindered deflection of the articulated mast along the arc and clearance-free guiding in the transverse direction.

16. A method for longitudinally positioning the storage and retrieval unit at a site of operation of the shelf in accordance with one of the claims 1 through 15, comprising:
operating the longitudinal drive or said longitudinal drives is/are operated such that the articulated mast is arranged vertically during normal operation of a longitudinal displacement of the storage and retrieval unit; and that providing guided deflection of the articulated mast and guided return of the articulated mast in case of an emergency stop of the storage and retrieval unit.

17. A method for longitudinally positioning the storage and retrieval unit at a site of operation of the shelf, the method comprising the steps of:
providing a vertical mast as an articulated mast with a joint allowing a deflection of the articulated mast in the direction of longitudinal displacement and a guide/readjusting device with articulated rods and/or an articulated oscillating crank, which returns the articulated mast into the normal position upon a guided deflection of the articulated mast from the vertical normal position for stabilization at the deflectable longitudinal end of the articulated mast;
providing a longitudinal drive connected to the mast for longitudinal displacement and longitudinal positioning of the vertical mast at a site of operation of the shelf on the shelf front or the shelf rear;
providing a height-adjustable goods receiver;
displacing the storage and retrieval unit linearly in the longitudinal direction of the shelf from a resting starting position of the shelf in an accelerated manner to a selected site of operation of the shelf and in a decelerated manner before the site of operation is reached in such a way that the articulated mast is deflected in a guided manner during at least part of the accelerated and/or decelerated motion and is again returned in a guided manner into the aligned vertical normal position at least during stoppage of the storage and retrieval unit.
